(19) United States
(12) Patent Application Publication
(10) Pub. No.: US 2010/0041260 A1
(43) Pub. Date: Feb. 18, 2010

(54) Memory card connector

(76) Inventors: Ming Chun Lai, Tu-Cheng City (TW); Yu Li, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/222,616

(22) Filed: Aug. 13, 2008

(51) Int. Cl. H01R 13/62

(52) U.S. Cl. 439/152

(57) ABSTRACT

A memory card connector adapted for accommodating a memory card includes a dielectric housing, a plurality of terminals received in the dielectric housing, a primary ejector and a secondary ejector. The dielectric housing defines a recess for accommodating the memory card. The primary ejector is received in one lateral side of the dielectric housing for ejecting the memory card out of the dielectric housing. The secondary ejector is received in the other lateral side of the dielectric housing for cooperating with the primary ejector to push the memory card out of the dielectric housing. After the memory card is fully inserted in the recess, the primary ejector stores an elastic force therein but is controlled to provide a substantially zero pushing force to the memory card. At the same time, the secondary ejector is still elastically urged against the memory card by an elastic force stored therein.

### BACKGROUND OF THE INVENTION

1. Field of the Invention

The present invention relates to a connector, and more particularly to a memory card connector.

2. The Related Art

A conventional memory card connector applied to portable telephones and the like has a dielectric housing, a shell covering the dielectric housing, an ejecting apparatus and a plurality of conductive terminals received in the dielectric housing. The ejecting apparatus is located in the dielectric housing and used to eject a memory card from the conventional memory card connector.

The conventional memory card connector described above has only one ejector which is placed on one side of the dielectric housing. When the memory card is inserted into the conventional memory card connector, the memory card is easy to be misaligned in the conventional memory card connector due to some improper insertion. Meanwhile, the memory card is easy to be locked in the conventional memory card connector while the memory card is located in the conventional memory card connector in a misaligned manner. Thus, when the misaligned memory card is injected and/or ejected from the conventional memory card connector, both the memory card and the conventional memory card connector are easy to be destroyed.

### SUMMARY OF THE INVENTION

An object of the present invention is to provide a memory card connector which can ensure a memory card be injected/ejected from the memory card connector smoothly and error-freely. The memory card connector adapted for accommodating a memory card includes a dielectric housing, a plurality of terminals received in the recess of the dielectric housing, a primary ejector and a secondary ejector. The dielectric housing defines a recess for accommodating the memory card. The primary ejector is received in one lateral side of the dielectric housing for ejecting the memory card out of the dielectric housing. The secondary ejector is received in the other lateral side of the dielectric housing for cooperating with the primary ejector to pushing the memory card out of the dielectric housing. The secondary ejector includes a secondary slider for pushing the memory card and an auxiliary elastic element disposed between the secondary slider and a rear of the dielectric housing opposite to an entrance of the recess from which the memory card is inserted inside the recess. After the memory card is fully inserted in the recess, the primary ejector stores an elastic force therein which is also controlled to provide a substantially zero pushing force to the memory card, the secondary ejector is still elastically urged against the memory card by an elastic force stored therein.

The secondary ejector provides an equilibrant during the injecting/ejecting process and cooperates with the primary ejector to eject the memory card from the memory card connector. Thereby the memory card connector of the present invention can prevent the memory card being misaligned or improperly blocked in the memory card connector during the injecting/ejecting process.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a memory card connector according to the present invention and a memory card to be inserted into the connector;

FIG. 2 is an exploded view of the memory card connector in FIG. 1;

FIG. 3 is a perspective view of a primary slider of the memory card connector in FIG. 2;

FIG. 4 is another perspective view of the primary slider of the memory card connector in FIG. 2;

FIG. 5 is a perspective view of a secondary slider of the memory card connector in FIG. 2;

FIG. 6 is a perspective view of a dielectric housing of the memory card connector in FIG. 2; and

FIG. 7 is a bottom plan view of the memory card inserted into the memory card connector, wherein a shell of the memory, card connector is removed to show the interior of the memory card connector.

### DETAILED DESCRIPTION OF THE PREFERRED EMBODIMENT

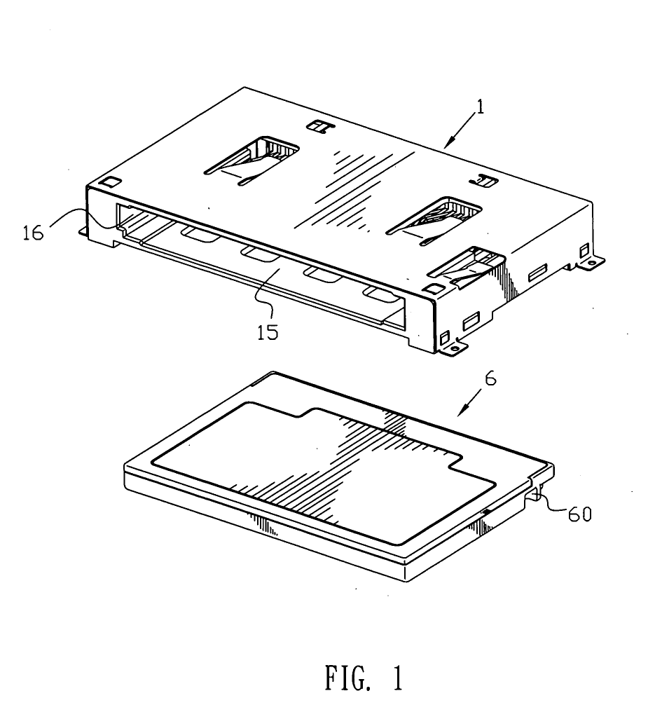

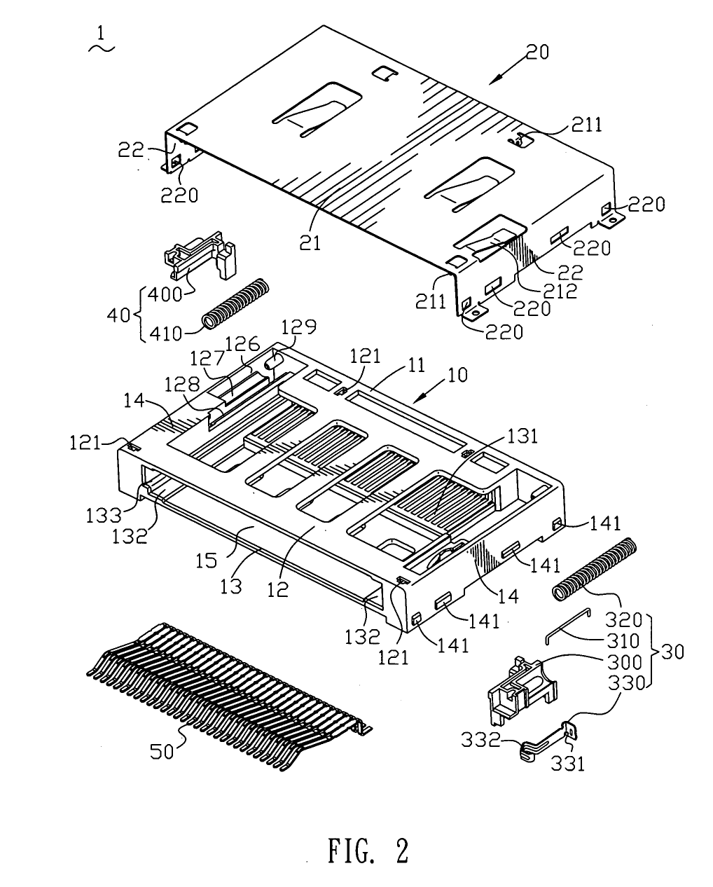

With reference to FIGS. 1 and 2, a memory card connector 1 adapted for accommodating a memory card 6 includes a dielectric housing 10, a plurality of conductive terminals 50 mounted in the dielectric housing 10, a shell 20 which is used to cover partially the dielectric housing 10, a primary ejector 30 and a secondary ejector 40.

With reference to FIGS. 2 and 6, the dielectric housing 10 defines a rear wall 11, a top wall 12, a bottom wall 13 and two sidewalls 14, all of which define a recess 15 therebetween in combination. A plurality of terminal grooves 131 is formed in the bottom wall 13 for receiving the conductive terminals 50. Two supporting portions 132 protrude upward from the junctions of the bottom wall 13 and the two sidewalls 14. In addition, a supporting beam 133 protrudes from the junction of the corresponding supporting portion 132 and a corresponding sidewall 14. A plurality of slits 121 is formed in the top wall 12 especially at corners thereof. A heart-shaped guide slot 122 is formed in the front of the junction of the top wall 12 and one of the sidewalls 14. A first receiving groove 123 is formed behind the rear end of the guide slot 122 and communicates with the recess 15. A lump 124 protrudes from a bottom side of the first receiving groove 123. A first holding rod 125 is formed on the rear wall 11 and extends into the first receiving groove 123. A second receiving groove 126 is formed in the other sidewall 14 and opposite to the first receiving groove 123. The second receiving groove 126 also communicates with the recess 15. A spring receiving groove 127 is formed on a bottom side of the second receiving groove 126. A leading groove 128 is formed to be adjacent to and parallel to the spring receiving groove 127. A second holding rod 129 is formed on the rear wall 11 and extends into the second receiving groove 126. A plurality of protrusions 141 are formed on an outer surface of each of the sidewalls 14.

Referring to FIG. 2, the shell 20 for covering at least partially the dielectric housing 10 has a top board 21 and two sideboards 22 formed at two lateral sides of the top board 21 respectively. A plurality of inserting tongues 211 is formed by cutting off part material of the top board 21 at first to define plural bendable tabs and then bending downwardly the tabs. Each inserting tongue 211 is able to be inserted into respective slit 121 of the dielectric housing 10 so as to secure the housing 10 and the shell 20 together. A pressing piece 212 is formed in a manner similar to the inserting tongue 211 and extending slantways and downwardly from the top board 21. A plurality of fixing holes 220 is formed in the two sideboards 22 to respectively mate with the corresponding protrusions 141 of the dielectric housing 10.

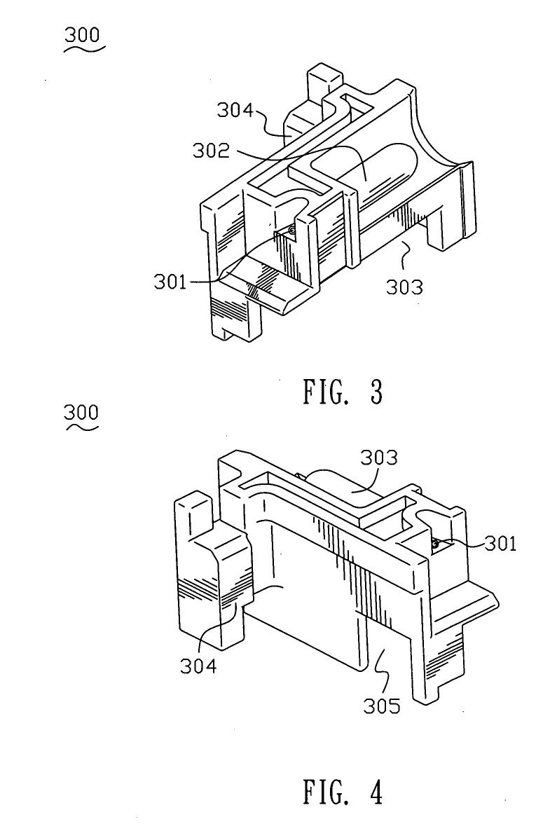

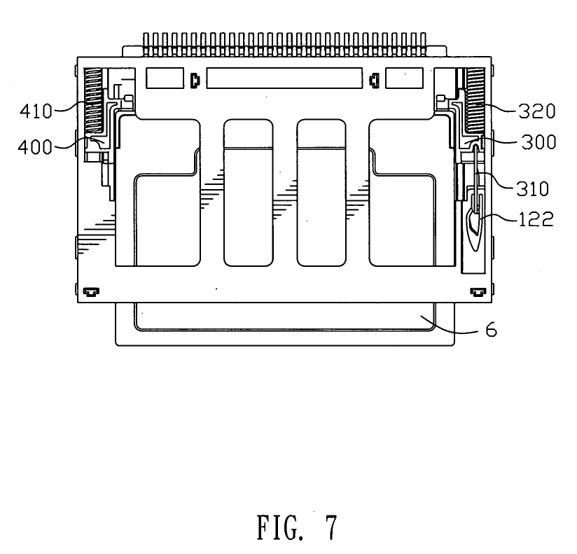

Please refer to FIGS. 2, 3, 4 and 7, the primary ejector 30 is a push/push type ejector. The primary ejector 30 may be received in the first receiving groove 123 and may include a primary slider 300, a guide pin 310, a primary elastic element 320 and a latching member 330. In this embodiment, the primary elastic element is a coil-shaped primary spring 320. The primary slider 300 is slidably arranged in the first receiving groove 123. A front end of one side of the primary slider 300 is depressed and defines a connecting hole 301 therein, and a rear end thereof defines a primary positioning pillar 302 corresponding to the first holding rod 125. A receiving space 303 is formed in the bottom of the primary slider 300. The rear end of the other side of the primary slider 300 protrudes outward to form a primary pushing portion 304. When assembled, the primary pushing portion 304 extends into the recess 15 of the dielectric housing 10 and is supported on one of the supporting portions 132. A notch 305 is formed in one side of the receiving space 303 near the primary pushing portion 304. One end of the guide pin 310 is fixed in the connecting hole 301 and the other end of the guide pin 310 is slidably received in the guide slot 122. The pressing piece 212 of the shell 20 continuously presses the guide pin 310 to prevent the guide pin 310 from moving out of the guide slot 122. Two opposite ends of the primary spring 320 are disposed on the first holding rod 125 and the primary positioning pillar 302 respectively.

The latching member 330 is received in the receiving space 303 of the primary slider 300. A fixing portion 331 is bent perpendicularly from one end of the latching member 330 and a contact portion 332 of a substantially U-shape is formed at the other end of the latching member 330. The fixing portion 331 is fixed in a rear side of the receiving space 303 and the contact portion 332 extends into the recess 15 of the dielectric housing 10 via the notch 305.

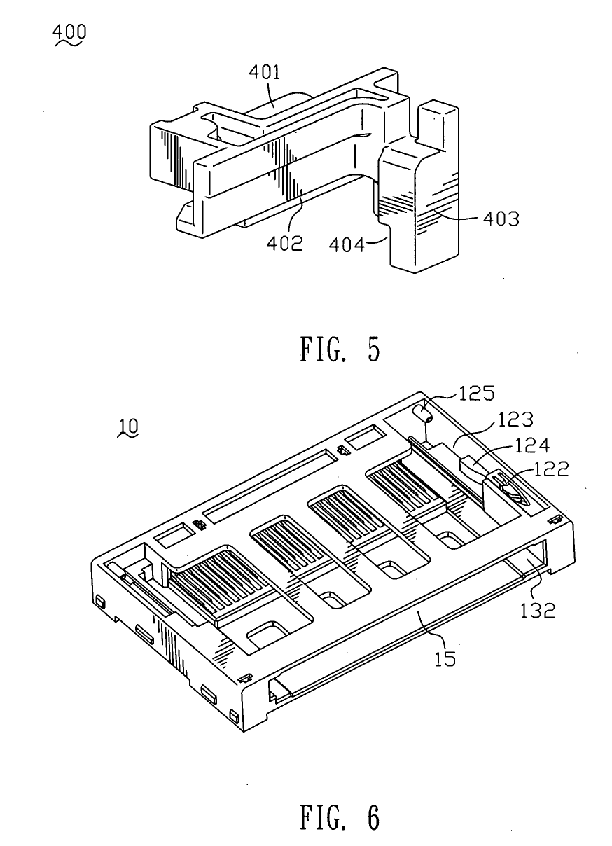

Please refer to FIGS. 2 and 5, the secondary ejector 40 may be received in the second receiving groove 126 and may include a secondary slider 400 and an auxiliary elastic element 410. In this embodiment, the auxiliary elastic element is a coil-shaped auxiliary spring 410. The secondary slider 400 is slidably arranged in the second receiving groove 126. A secondary positioning pillar 401 is formed at a rear end of one side of the secondary slider 400 corresponding to the second holding rod 129. A bump 402 extending longitudinally is formed on a bottom side of the secondary slider 400. The bump 402 slides in the leading groove 128. The rear end of the other side of the secondary slider 400 protrudes outward to form a secondary pushing portion 403. The secondary pushing portion 403 also extends into the recess 15 of the dielectric housing 10 and is supported by the other supporting portion 132. A stepped portion 404 is formed in one side of a lower portion of the secondary pushing portion 403 near the bump 402. The stepped portion 404 slides on the supporting beam 133 of the dielectric housing 10. The auxiliary spring 410 is received in the spring receiving groove 127. Two opposite ends of the auxiliary spring 410 are disposed on the second holding rod 129 and the secondary positioning pillar 401 respectively. In this embodiment, the position of the secondary pushing portion 403 is closer to the rear wall 11 of the dielectric housing 10 than that of the primary pushing portion 304 when the memory card 6 is not inserted into the memory card connector 1.

Please refer to FIGS. 1, 2 and 7, when the memory card 6 with a groove 60 defined at a lateral side thereof is inserted into the recess 15 from an entrance 16 for the memory card connector 1, because the position of the primary pushing portion 304 is farther from the rear wall 11 than that of the secondary pushing portion 403, a leading end of the memory card 6 will firstly contact and then push the primary pushing portion 304 of the primary slider 300 backwardly. With the further movement of the card 6, the leading end thereof begins to contact the secondary pushing portion 403 of the secondary slider 400 and pushes the secondary pushing portion 403 and the primary pushing portion 304 together. The primary spring 320 and the auxiliary spring 410 are respectively compressed and the guide pin 310 is driven to move backwards along the guide slot 122 until the end of the guide pin 310 slides into a concave (not labeled) of the guide slot 122. Then the primary ejector 30 reaches a stay state and the memory card 6 is held in the memory card connector 1 and electrically connects with the conductive terminals 50 steadily. When the memory card 6 is fully inserted into the memory card connector 1, the contact portion 332 of the latching member 330 will readily embedded into the groove 60 of the memory card 6. The primary ejector 30 stores an elastic force therein but is controlled to provide a substantially zero pushing force to the memory card 6. The secondary slider 400 is still elastically urged against the memory card 6 by an elastic force stored in the auxiliary spring 410. As the position of the secondary pushing portion 403 is closer to the rear wall 11 than that of the primary pushing portion 304, the distance by which the auxiliary spring 410 is compressed is shorter than that of the primary spring 320 which makes the elasticity of the auxiliary spring 410 exerted on the secondary slider 400 is smaller than that of the primary spring 320 exerted on the primary slider 300. So the push force provided by the auxiliary spring 410 is not big enough to push the memory card 6 out when the memory card 6 reaches a stay state in the memory card connector 1.

When the memory card 6 is to be ejected from the memory card connector 1, a user may push the memory card 6 to make the guide pin 310 move out of the concave of the guide slot 122. And then the guide pin 310 slides in another side of the guide slot 122. The primary spring 320 and the auxiliary spring 410 are released synchronously. The memory card 6 is pushed outward by the primary slider 300 and the secondary slider 400 which are respectively pushed by the primary spring 320 and the auxiliary spring 410. The contact portion 332 of the latching member 330 gets out of the groove 60 of the memory card 6. The primary slider 300 and the secondary slider 400 respectively provide a push force on two sides of the memory card 6 which makes the memory card 6 eject from the memory card connector 1 smoothly.

As described above, the primary ejector 30 and the secondary ejector 40 are respectively disposed at two sides of the dielectric housing 10. The secondary ejector 40 provides an equilibrant during the injecting/ejecting process of the memory card 6 and cooperates with the primary ejector 30 to eject the memory card 6 from the memory card connector 1. Thereby the memory card connector 1 of the present invention can prevent the memory card 6 being misaligned or improperly blocked in the memory card connector 1 during the injecting/ejecting process.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A memory card connector adapted for removably receiving a memory card therein without any misalignment or improper blockage of the memory card inside the connector, comprising:
a dielectric housing defining a recess for accommodating the memory card;
a plurality of terminals received in the recess of the dielectric housing for electrically connecting with the memory card;
a primary ejector slideably and resiliently received in one lateral side of the dielectric housing for ejecting the memory card out of the dielectric housing; and
a secondary ejector received in the other lateral side of the dielectric housing for cooperating with the primary ejector to push the memory card out of the dielectric housing, the secondary ejector including a secondary slider for pushing the memory card and an auxiliary elastic element secured between the secondary slider and a rear of the dielectric housing opposite to an entrance of the recess from which the memory card is inserted into the recess;
wherein after the memory card is fully inserted in the recess, the primary ejector stores an elastic force therein but is also controlled to provide a substantially zero pushing force to the memory card, whereas the secondary slider is still elastically urged against the memory card by an elastic force stored in the auxiliary elastic element.

2. The memory card connector as claimed in claim 1, wherein the primary ejector is a push/push type and comprises a primary slider, a primary elastic element secured between the primary slider and the rear of the dielectric housing, a guide slot means provided in the front of the side of the dielectric housing and corresponding to the primary ejector, and a guide pin, and wherein one end of the guide pin is slidably engaged in the guide slot, whilst the other end thereof is connected to the primary slider for cooperating with the primary elastic element to control movement of the primary slider in a push/push action.

3. The memory card connector as claimed in claim 2, wherein the primary slider defines a primary pushing portion extended into the recess for pushing the memory card, the secondary slider defines a secondary pushing portion extended into the recess for pushing the memory card, and during insertion of the memory card, the primary pushing portion will be firstly contacted with respect to the secondary pushing portion.

4. The memory card connector as claimed in claim 1, wherein the auxiliary elastic element is a coil-shaped compressible spring.

5. A memory card connector adapted for accommodating a memory card therein, comprising:
a dielectric housing defining a recess for accommodating the memory card therein;
a plurality of terminals received in the recess of the dielectric housing for electrically connecting with the memory card;
a primary ejector received in one lateral side of the dielectric housing for pushing the memory card out of the dielectric housing; and
a secondary ejector received in the other lateral side of the dielectric housing for cooperating with the primary ejector to pushing the memory card out of the dielectric housing;
wherein after the memory card is fully inserted in the recess, the primary ejector stores an elastic force therein while is also controlled to provide a substantially zero pushing force to the memory card, whereas the secondary slider is still elastically urged against the memory card by an elastic force stored in the auxiliary elastic element.
